(19) United States
(12) Patent Application Publication
(10) Pub. No.: US 2024/0044640 A1
(43) Pub. Date: Feb. 8, 2024

(54) SPECKLE GENERATION METHOD, ELECTRONIC DEVICE, AND COMPUTER READABLE STORAGE MEDIUM

(71) Applicant: Zhuhai Prometheus Vision Technology Co., LTD, Zhuhai (CN)

(72) Inventors: Zhijing SHAO, Zhuhai (CN); Yu ZHANG, Zhuhai (CN); Wei SUN, Zhuhai (CN)

(21) Appl. No.: 18/093,405

(22) Filed: Jan. 5, 2023

(30) Foreign Application Priority Data
Aug. 5, 2022 (CN) 202210940162.8

(51) Int. Cl. G01B 11/25; G06T 17/30

(52) U.S. Cl. CPC G01B 11/2513; G06T 17/30; G06T 7/40

(57) ABSTRACT

Embodiments of this application discloses a speckle generation method, electronic device, and computer readable storage medium. The method includes: dividing a projection area of a speckle projector into a plurality of polygons, and determining a plurality of candidate projection points and a plurality0 of candidate projection edges based on vertices and edges of the polygons; generating a random number, and selecting a target projection point from the plurality of candidate projection points and selecting a target projection edge from the plurality of candidate projection edges based on the random number; and generating a speckle pattern based on the target projection point and the target projection edge. By dividing the projection area of the speckle projector into the plurality of polygons, and taking the vertices and edges of the polygons as the candidate projection points and projection edges, the speckle density can be controlled by controlling sizes of the polygons.

### CROSS-REFERENCE TO RELATED APPLICATIONS

This application claims priority of Chinese Patent Application No. 202210940162.8 filed on Aug. 5, 2022, and titled “SPECKLE GENERATION METHOD, APPARATUS, ELECTRONIC DEVICE, AND COMPUTER READABLE STORAGE MEDIUM”, which is incorporated by reference in its entirety in the present application.

### TECHNICAL FIELD

Embodiments of this application relate to a technical field of computers, and in particular to a speckle generation method, electronic device, and computer-readable storage medium.

### TECHNICAL BACKGROUND

With rapid development of computer technology, an application of three-dimensional reconstruction is more and more extensive. At present, through projecting speckles on a reconstructed object, a three-dimensional object model can be reconstructed using the speckles.

However, at present, the speckles are mainly projected in a random way, which is difficult to control sparsity of the speckles. This is not conducive to obtaining texture information of the reconstructed object.

### SUMMARY

Embodiments of this application provide a speckle generation method, apparatus, electronic device, and computer readable storage medium, which can realize control of speckle density and facilitate acquisition of texture information.

In a first aspect, an embodiment of this application provides a speckle generation method, which includes:

dividing a projection area of a speckle projector into a plurality of polygons, and determining a plurality of candidate projection points and a plurality of candidate projection edges based on vertices and edges of the polygons;

generating a random number, and selecting a target projection point from the plurality of candidate projection points and selecting a target projection edge from the plurality of candidate projection edges based on the random number; and

generating a speckle pattern based on the target projection point and the target projection edge.

In a second aspect, embodiments of this application further provide a speckle generation apparatus, which includes:

a determination module configured to drive a projection area of a speckle projector into a plurality of polygons, and determine a plurality of candidate projection points and a plurality of candidate projection edges based on vertices and edges of the polygons;

a selection module configured to generate a random number, and select a target projection point from the plurality of candidate projection points and select a target projection edge from the plurality of candidate projection edges based on the random number; and

a generation module configured to generate a speckle pattern based on the target projection point and the target projection edge.

Wherein, in some embodiments of this application, the selection module includes:

a density determination unit configured to determine a speckle density value;

a selection unit configured to generate the random number, and select the target projection point from the plurality of candidate projection points and select the target projection edge from the plurality of candidate projection edges based on a comparison result between the random number and the speckle density value.

Wherein, in some embodiments of this application, the selection module includes:

a density determination subunit configured to determine the speckle density value according to a precision requirement parameter of an input, and/or, determine the speckle density value according to a texture characteristic of an object to be projected.

Wherein, in some embodiments of this application, the selection module includes:

a generation subunit configured to generate a point random number for each of the candidate projection points, and generate an edge random number for each of the candidate projection edges;

a first selection subunit configured to select the target projection point from the plurality of candidate projection points based on a comparison result between the point random number for each of the candidate projection points and the speckle density value; and

a second selection subunit configured to select the target projection edge from the plurality of candidate projection edges based on a comparison result between the edge random number for each of the candidate projection edges and the speckle density value.

Wherein, in some embodiments of this application, the speckle density value includes a point density value, and the first selection subunit is specifically configured to:

for each of the candidate projection points, determine a point selection state of the candidate projection point based on the comparison result between the point random number of the candidate projection point and the point density value; and

determine the target projection point from the plurality of candidate projection points based on the point selection state of each of the candidate projection points.

Wherein, in some embodiments of this application, the speckle density value includes an edge density value, and the second selection subunit is specifically configured to:

for each of the candidate projection edges, determine an edge selection state of the candidate projection edge based on the comparison result between the edge random number of the candidate projection edge and the edge density value; and

determine the target projection edge from the plurality of candidate projection edges based on the edge selection state of each of the candidate projection edges.

Wherein, in some embodiments of this application, the polygon includes rectangles, and the determination module includes:

a point determination unit configured to, for each of the rectangles, take any one vertex of the rectangle as a candidate projection point, and positions of the candidate projection points corresponding to the rectangles are consistent, wherein the positions include a position of the candidate projection point relative to the rectangle; and

an edge determination unit configured to take two edges of the rectangle connected with the candidate projection point as the candidate projection edges respectively.

Wherein, in some embodiments of this application, the two edges include first edges and second edges, the speckle density value includes a first edge density value corresponding to the first edges and a second edge density value corresponding to the second edges, and the second selection subunit is further specifically configured to:

for each of the first edges, determine an edge selection state of the first edge based on a comparison result between an edge random number corresponding to the first edge and the first edge density value; and

for each of the second edges, determine an edge selection state of the second edge based on a comparison result between an edge random number corresponding to the second edge and the second edge density value.

Wherein, in some embodiments of this application, the determination module includes:

a size determination unit configured to, in response to a speckle generation instruction for the projection area of the speckle projector, determine a division size; and

a division unit configured to divide the projection area of the speckle projector into a plurality of polygons.

Wherein, in some embodiments of this application, the apparatus further includes a depth calculation module, and the depth calculation module includes:

a projection unit configured to project the speckle pattern to an object to be projected at a current visual angle of a current moment;

a shooting unit configured to shoot the object to be projected that has been projected by a binocular camera to obtain a first shot image and a second shot image; and

a calculation unit configured to, based on a parallax error of the speckle pattern in the first shot image and the second shot image, determine depth information of the object to be projected at the current visual angle of the current moment.

Wherein, in some embodiments of this application, the apparatus further includes a modeling module, and the modeling module includes:

an obtaining unit configured to, based on the speckle pattern, obtain depth information of the object to be projected at other visual angles of the current moment except the current visual angle; and

a modeling unit configured to model the object to be projected based on the obtained depth information to obtain a three-dimensional object model at the current moment.

Wherein, in some embodiments of this application, the apparatus further includes a volumetric video generation module, and the volumetric video includes:

a multi-moment modeling unit configured to model the object to be projected at other moments except the current moment to obtain a three-dimensional object model of the object to be projected at the other moment; and

a volumetric video generation unit configured to perform video coding on the modeled three-dimensional object model according to a time sequence to obtain a volumetric video of the object to be projected.

In a third aspect, an embodiment of this application further provides an electronic device, the electronic device includes a memory, a processor, and a computer program stored in the memory and executable on the processor, and the processor executes the computer program to realize the steps of the speckle generation method as described above.

In a fourth aspect, an embodiment of this application also provides a computer readable storage medium, on which a computer program is stored, wherein when the computer program is executed by a processor, the computer program implements the steps of the speckle generation method as described above.

Wherein, the embodiments of this application divide a projection area of a speckle projector into a plurality of polygons; obtain a plurality of candidate projection points and a plurality of candidate projection edges based on vertices and edges of the polygons; by generating a random number, select a target projection point from the plurality of candidate projection points and select a target projection edge from the plurality of candidate projection edges based on the random number; and then generate a speckle pattern based on the selected target projection point and the selected target projection edge. Wherein, by constructing the speckle pattern through the points and edges, diversity of the speckle pattern texture is enriched. Compared to speckles constructed by random points in the related art, it is easier to obtain texture of a surface of a projected object through the speckles constructed by the points and edges in the present solution. Wherein, selecting the projection points and edges based on the random numbers improves randomness of the speckle pattern, and such a random way can also make speckles more uniform to a certain extent. Wherein, by dividing the projection area of the speckle projector into the plurality of polygons, and taking the vertices and the edges of the polygons as the candidate projection points and the candidate projection edges, the speckle density can be controlled by controlling sizes of the polygons.

### BRIEF DESCRIPTION OF THE DRAWINGS

In order to more clearly explain technical solutions in this application, the following will briefly introduce drawings needed in the description of the embodiments. Obviously, the drawings in the following description are only some of the embodiments of this invention. For those skilled in the art, other drawings can be obtained according to these drawings without any creative effort.

FIG. 1 is a scene schematic diagram of a speckle generation method provided by an embodiment of this application.

FIG. 2 is a flow diagram of the speckle generation method provided by an embodiment of this application.

FIG. 3 is a schematic picture of dividing a projection area of a speckle projector according to rectangles provided by an embodiment of this application.

FIG. 4 is a flow diagram of a rectangle-based speckle generation method provided by an embodiment of this application.

FIG. 5 is a first schematic picture of a speckle pattern provided by an embodiment of this application.

FIG. 6 is a second schematic picture of the speckle pattern provided by an embodiment of this application.

FIG. 7 is a third schematic picture of the speckle pattern provided by an embodiment of this application.

FIG. 8 is a fourth schematic picture of the speckle pattern provided by an embodiment of this application.

FIG. 9 is a schematic picture of random speckles based on projection points in the related art.

FIG. 10 is a schematic picture of another random speckle pattern based on the projection points in the related art.

FIG. 11 is a schematic picture of a speckle pattern application provided by an embodiment of this application.

FIG. 12 is a schematic structural diagram of a speckle generation apparatus provided by an embodiment of this application.

FIG. 13 is a schematic structural diagram of an electronic device provided by an embodiment of this application.

### DETAILED DESCRIPTION

Technical solutions in this application will be clearly and completely described hereinafter with reference to accompany drawings in this application. Obviously, the described embodiments are only part of embodiments of the present invention, but not all of them. Based on the embodiments of the present invention, all other embodiments obtained by those skilled in the art without creative labor belong to the scope of the present invention.

Embodiments of this application provide a speckle generation method, apparatus, electronic device, and computer readable storage medium. Specifically, an embodiment of this application provides a speckle generation apparatus suitable for an electronic device. The electronic device includes a terminal device. The terminal device can be a computer, a light emitter (such as a laser or a laser emitter), etc.

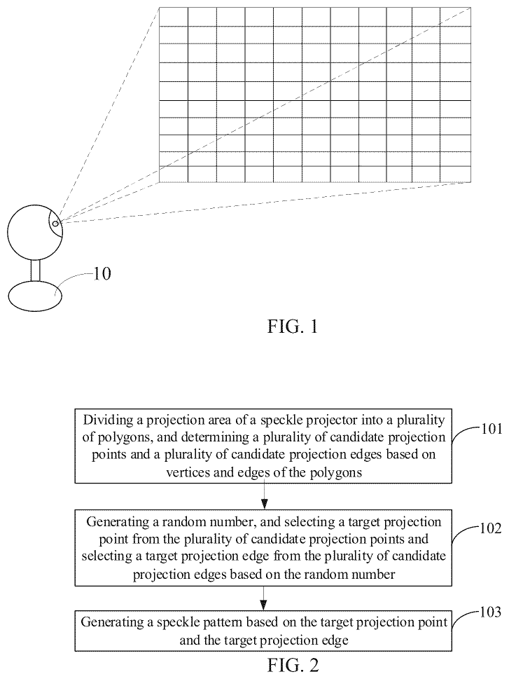

Please refer to FIG. 1, taking the speckle generation method executed by the terminal device as an example, wherein a specific execution process of the speckle generation method is as follows:

The terminal 10 divides a projection area of a speckle projector corresponding to a projection range of the terminal 10 into a plurality of polygons, and determines a plurality of candidate projection points and a plurality of candidate projection edges based on vertices and edges of the polygons; then generates a random number, and selects a target projection point from the plurality of candidate projection points and selects a target projection edge from the plurality of candidate projection edges based on the random number; and generates a speckle pattern based on the target projection point and the target projection edge.

Wherein, the embodiment of this application divides the projection area of the speckle projector into the plurality of polygons; obtains the plurality of candidate projection points and the plurality of candidate projection edges based on the vertices and the edges of the polygons; by generating the random number, select the target projection point from the plurality of candidate projection points based on the random number, and select the target projection edge from the plurality of candidate projection edges based on the random number; and then generates the speckle pattern based on the selected target projection point and the selected target projection edge. Wherein, by constructing the speckle pattern through the points and edges, diversity of the speckle pattern texture is enriched. Compared to speckles constructed by random points in the related art, it is easier to obtain texture of a surface of a projected object through the speckles constructed by the points and edges in the present solution. Wherein, selecting the projection points and edges based on the random numbers improves randomness of the speckle pattern, and such a random way can also make speckles more uniform to a certain extent. Wherein, by dividing the projection area of the speckle projector into the plurality of polygons, and taking the vertices and the edges of the polygons as the candidate projection points and the candidate projection edges, the speckle density can be controlled by controlling sizes of the polygons.

The details are described below. It should be noted that a description order of the following embodiments is not to limit a priority order of the embodiments.

Please refer to FIG. 2, FIG. 2 is a flow diagram of the speckle generation method provided by an embodiment of this application. A specific flow of the speckle generation method can be as follows:

101: dividing a projection area of a speckle projector into a plurality of polygons, and determining a plurality of candidate projection points and a plurality of candidate projection edges based on vertices and edges of the polygons.

In the embodiment of this application, the projection area of the speckle projector is an area corresponding to a projection range of a device. After projecting light, the device forms speckles in the projection area of the speckle projector corresponding to the projection range. The device includes a laser emitting device.

Wherein, in the embodiment of this application, the polygons include a geometric figure formed by a plurality of edges, such as a triangle, a rectangle, or a square. Wherein, in the embodiment of this application, the polygons include regular graphics, and the regular graphics facilitate division of the projection area of the speckle projector. For example, if the projection area of the speckle projector is divided into rectangles, the projection area of the speckle projector can be equally divided according to the rectangles.

Wherein, in the embodiment of this application, the vertices of the polygon can be used as the candidate projection points, and the edges of the polygon can be used as the candidate projection edges. Wherein, by taking the vertices of the polygon as the candidate projection points and the edges of the polygon as the candidate projection edges, positions of the projection points and positions and lengths of the projection edges can be controlled through controlling width and height of the polygons, so as to realize controlling density of the projection points and the projection edges and further realize controlling sparsity of the speckles. By controlling the sparsity of the speckles, it is convenient to obtain more texture information of the projected object, and the more texture information makes it convenient to calculate depth information and three-dimensional data of the projected object.

Wherein, after taking the vertices of the polygon as the projection points, sizes of the projection points can be adjusted through adjusting sizes of the vertices, and lengths and thicknesses of the projection edges can be adjusted through adjusting lengths and thicknesses of the edges of the polygons, thereby obtaining different speckle patterns.

Wherein, in the embodiment of this application, sizes of the polygons can be controlled. The speckle density can be adjusted by controlling the sizes of the polygons. That is, alternatively, in some embodiments of this application, the operation of “dividing the projection area of the speckle projector into the plurality of polygons” includes:

in response to a speckle generation instruction for the projection area of the speckle projector, determining a division size;

dividing the projection area of the speckle projector into the plurality of polygons.

Wherein, in the embodiment of this application, the division size corresponds to the sizes of the polygons and is used to control the sizes of the divided polygons. Wherein, in the embodiment of this application, size data of the polygon can be obtained by analyzing the speckle generation instruction, or the division size can be obtained by directly receiving division data input by a user.

In the embodiment of this application, the polygon can be a rectangular.

Correspondingly, the vertices of the rectangle can be used as the candidate projection points, and the edges of the rectangle can be used as the candidate projection edges. That is, alternatively, in some embodiments of this application, the polygons include rectangles, and the operation of “determining the plurality of candidate projection points and the plurality of candidate projection edges based on the vertices and edges of the polygons” includes:

for each of the rectangles, taking any one vertex of the rectangle as a candidate projection point, and positions of the candidate projection points corresponding to the rectangles are consistent, wherein the positions include a position of the candidate projection point relative to the rectangle;

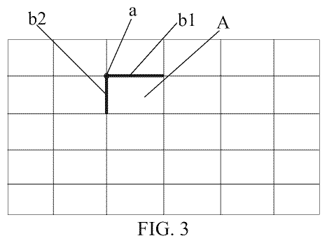

taking two edges of the rectangle connected with the candidate projection point as the candidate projection edges respectively.

Wherein, dividing the projection area of the speckle projector by the rectangle can divide the projection area of the speckle projector evenly and thoroughly. Wherein, dividing the projection area of the speckle projector by the rectangle can also make the speckles more uniform.

Wherein, for each rectangle, any one vertex in the rectangle can be taken as the candidate projection point. For each candidate projection point in the projection area of the speckle projector, the candidate projection point can correspond to one rectangle. For example, the candidate projection point is located at any of four vertices in the rectangle.

Wherein, in the embodiment of this application, a position of each candidate projection point relative to the rectangle is set in a similar manner, so that each candidate projection point can correspond to one rectangle. By establishing a corresponding relationship between the projection point and the rectangle, repeated calculation or selection of the candidate projected points can be avoided. For example, there are repeated vertices in adjacent rectangles, and taking a vertex corresponding to an upper left corner of a rectangle as the candidate projection point can make each rectangle corresponds to one candidate projection point, and each candidate projection point corresponds to a rectangle, thus effectively avoiding repeated use or repeated selection of the candidate projection points.

Wherein, in the embodiment of this application, for the polygons, such as a quadrilateral (such as a rectangle), each vertex can be correspondingly connected with two edges. Therefore, after one-to-one correspondence between each rectangle and each candidate projection point is determined, the two edges connected with the candidate projection point can be respectively used as the candidate projected edges. For example, please refer to FIG. 3, the rectangle in the quadrilateral is taken as an example. Meanwhile, the embodiment of this application is also applicable to other shapes that can be tiled, such as a triangle, a hexagon. FIG. 3 is a schematic picture of dividing the projection area of the speckle projector according to rectangles provided by an embodiment of this application, wherein point a is a vertex of a rectangle A, and is also a candidate projection point corresponding to the rectangle A. Correspondingly, edges b1 and b2 connected with the point A in the rectangle A are two candidate projection edges corresponding to the rectangle A. Taking the edges connected with the candidate projection point as the projection edges can also avoid repeated selection and use of rectangular edges, avoiding repeated use of the candidate projection edges.

102: generating a random number, and selecting a target projection point from the plurality of candidate projection points and selecting a target projection edge from the plurality of candidate projection edges based on the random number.

Wherein, by selecting the projection points and the projection edges through the random number, the selection of projection points and projection edges has randomness, which facilitates a random distribution of the speckles.

Wherein, in the embodiment of this application, the speckle pattern can be controlled according to a density requirement of the speckles. Thus, after the random number is generated, the projection points and the projection edges can be selected based on a comparison result between the random number and a speckle density value. That is, alternatively, in some embodiments of this application, the operation of “generating the random number, and selecting the target projection point from the plurality of candidate projection points and selecting the target projection edge from the plurality of candidate projection edges based on the random number” includes:

determining the speckle density value;

generating the random number, and selecting the target projection point from the plurality of candidate projection points and selecting the target projection edge from the plurality of candidate projection edges based on the comparison result between the random number and the speckle density value.

Wherein, in the embodiment of this application, the speckle density value refers to a density of the speckles in the projection area of the speckle projector. In the embodiment of this application, the speckle density value can be expressed as a decimal number between 0 and 1, and different densities can be expressed according to different decimal values. For example, a decimal value corresponding to a ratio (e.g., a duty ratio) of a speckle area to the projection area of the speckle projector can be taken as the speckle density value. The speckle density value can be calculated through a rate of a number of pixels corresponding to the speckles to a number of pixels of the projection area of the speckle projector.

Wherein, in the embodiment of this application, the speckle density value can be controlled based on the user's requirements or determined based on texture of a surface of the object to be projected. That is, alternatively, in some embodiments of this application, the operation of “determining the speckle density value” includes:

determining the speckle density value according to a precision requirement parameter of an input, and/or, determining the speckle density value according to a texture characteristic of the object to be projected.

Wherein, in the embodiment of this application, the precision requirement parameter is input by the user according to a requirement, and the speckle density is controlled based on the parameter. That is, different speckle density values are obtained according to different precision requirement parameters.

Wherein, in the embodiment of this application, the texture characteristic of the object to be projected reflect complexity of the surface of the object to be projected. That is, in the embodiment of this application, the speckle density can be determined according to the complexity of the surface of the object to be projected. For example, for an object with high surface complexity, the speckle density can be increased to obtain more texture information of the surface of the object, while for an object with low surface complexity, the speckle density can be decreased, reducing light projection amount and resource cost.

Wherein, a random selection of the projection points and the projection edges can be controlled by the random number. The selection of the projection points and the projection edges based on the speckle density values can be realized by comparing the random number with the speckle density value, realizing controlling the speckle density. Wherein, in the embodiment of this application, the projection points or the projection edges can be selected by comparing the random numbers with the speckle density value. For example, in the embodiment of this application, the random number and the speckle density value can be set within a same numerical interval, and the projection points and the projection edges can be selected according to whether the random number is greater than the speckle density value.

Wherein, in the embodiment of this application, a random number for each candidate projection point can be generated, a random number for each candidate projection edge can be generated, and the projection points and the projection edges can be selected based on a comparison result between the random numbers and the speckle density value. That is, alternatively, in some embodiments of this application, the operation of “generating the random number, and selecting the target projection point from the plurality of candidate projection points and selecting the target projection edge from the plurality of candidate projection edges based on the comparison result between the random number and the speckle density value” includes:

generating a point random number for each of the candidate projection points, and generating an edge random number for each of the candidate projection edges;

selecting the target projection point from the plurality of candidate projection points based on a comparison result between the point random number for each of the candidate projection points and the speckle density value; and

selecting the target projection edge from the plurality of candidate projection edges based on a comparison result between the edge random number for each of the candidate projection edges and the speckle density value.

Wherein, by generating the point random number for each candidate projection point and generating the edge random number for each candidate projection edge, and the projection points and the projection edges can be selected based on the comparison results between each point random number and each edge random number and the speckle density value.

Wherein, in the embodiment of this application, for each candidate projection point, whether to use the candidate projection point as the target projection point can be determined based on the comparison result between the candidate projection point and the speckle density value. That is, alternatively, in some embodiments of this application, the speckle density value includes a point density value, and the operation of “selecting the target projection point from the plurality of candidate projection points based on the comparison result between the point random number for each of the candidate projection points and the speckle density value” includes:

for each of the candidate projection points, determining a point selection state of the candidate projection point based on the comparison result between the point random number of the candidate projection point and the point density value; and

determining the target projection point from the plurality of candidate projection points based on the point selection state of each of the candidate projection points.

Wherein, in the embodiment of this application, the point selection state includes selection and non-selection. The selection state of the candidate projection point can be determined based on the comparison result between the point random number and the point density value of the candidate projection point. For example, when the point random number corresponding to the candidate projection point is less than or equal to the point density value, the point selection state of the candidate projection point is selection, and when the point random number corresponding to the candidate projection point is greater than the point density value, the point selection state of the candidate projection point is non-selection. For example, taking the point density value and the point random number both of which are between 0 and 1 as an example, when the point density value is 0.7, it indicates that a point density of a desired speckle density is 0.7, and projection points with point random numbers of 0.7 or less can be taken as the target projection points. Based on a random principle, a ratio of the projection points with the point random numbers of 0.7 or less to all the projection points is also controlled to approximate to 70%. Therefore, based on the comparison result between the random number and the point density value, a selection density of the candidate projection points can be controlled, and then the speckle density can be controlled.

Wherein, in the embodiment of this application, for each candidate projection edge, whether the candidate projection edge is the target projection edge can be determined based on the comparison result between the candidate projection edge and the speckle density value. That is, alternatively, in some embodiments of this application, the speckle density value includes an edge density value, and the operation of “selecting the target projection edge from the plurality of candidate projection edges based on the comparison result between the edge random number for each of the candidate projection edges and the speckle density value” includes:

for each of the candidate projection edges, determining an edge selection state of the candidate projection edge based on the comparison result between the edge random number of the candidate projection edge and the edge density value; and

determining the target projection edge from the plurality of candidate projection edges based on the edge selection state of each of the candidate projection edges.

Wherein, in the embodiment of this application, the edge selection state includes selection and non-selection. The selection state of the candidate projection edge can be determined based on the comparison result between the edge random number and the edge density value of the candidate projected edge. For example, when the edge random number corresponding to the candidate projection edge is less than or equal to the edge density value, the edge selection state of the candidate projection edge is selection, and when the edge random number corresponding to the candidate projection edge is greater than the edge density value, the edge selection state of the candidate projection edge is non-selection. For example, taking the edge density value and the edge random number both of which are between 0 and 1 as an example, when the edge density value is 0.6, it indicates that an edge density of a desired speckle density is 0.6, and projection edges with edge random numbers of 0.6 or less can be taken as the target projection edges. Based on a random principle, a ratio of the projection edges with the edge random numbers of 0.6 or less to all the projection points is also controlled to approximate to 60%. Therefore, based on the comparison result between the random number and the edge density value, a selection density of the candidate projection edge can be controlled, and then the speckle density can be controlled.

In the embodiment of this application, when the polygons are rectangles, and each rectangle corresponds to two edges connected with the candidate projection point, whether the edge is taken as the candidate projected edge can be determined based on the density value corresponding to each edge. That is, alternatively, in some embodiments of this application, the two edges include first edges and second edges, the speckle density value includes a first edge density value corresponding to the first edges and a second edge density value corresponding to the second edges. The operation of “determining, for each of the candidate projection edges, the edge selection state of the candidate projection edge based on the comparison result between the edge random number of the candidate projection edge and the edge density value” includes:

for each of the first edges, determine an edge selection state of the first edge based on a comparison result between an edge random number corresponding to the first edge and the first edge density value; and

for each of the second edges, determining an edge selection state of the second edge based on a comparison result between an edge random number corresponding to the second edge and the second edge density value.

Wherein, the edge selection state corresponding to each edge can be determined by comparing the edge random number of each edge with the edge density value of each edge. For example, when the edge random number of the first edge is 0.3 and the edge density value of the first edge is 0.5, the first edge can be used as the target projection edge, and when the edge random number of the second edge is 0.5 and the edge density value of the second edge is 0.4, the second edge is not used as the target projection edge.

Wherein, when the first edge and the second edge are selected according to their corresponding edge density values, flexibility of each edge selection can be improved, an interference of the first edge to the second selection or an interference of the second selection to the first edge can be avoided, and an edge selection efficiency can be improved.

103: generating the speckle pattern based on the target projection point and the target projection edge.

Wherein, after the target projection point and the target projection edge are determined, a light projection position can be localized. Positions of the target projection point and the target projection edge correspond to positions of the speckles. Thus, the speckle pattern can be generated based on the target projection point and the target projection edge.

Wherein, after a projection position is determined, through projecting a light to the projection position, a speckle projection of the speckle pattern based on the projected position can be realized. In the embodiment of this application, the light includes a laser.

Wherein, in the embodiment of this application, after the speckle pattern is obtained, depth information of the object can be calculated according to the speckle pattern. That is, alternatively, in the embodiment of this application, the operation of “generating the speckle pattern based on the target projection point and the target projection edge” includes:

projecting the speckle pattern to the object to be projected at a current visual angle of a current moment;

shooting the object to be projected that has been projected by a binocular camera to obtain a first shot image and a second shot image; and

based on a parallax error of the speckle pattern in the first shot image and the second shot image, determining the depth information of the current visual angle of the object to be projected at the current moment.

Wherein, in the embodiment of this application, the binocular camera includes a structured light binocular depth camera, which is composed of one or more structured light emitters and two cameras. The two cameras capture images of structured light casting on the object, and perform depth calculation by calculating the parallax error.

The speckle is a pattern projected by a structured light transmitter. In order to provide strong texture information and unique texture, random speckles are generally used as the pattern.

Wherein, after the speckle pattern is projected on the object to be projected, roughness of a surface of the object to be projected can be obtained based on the speckle pattern, and parallax information of an image to be projected can be obtained through the first shot image and the second shot image, so as to obtain the depth information of the object to be projected.

Wherein, in the embodiment of this application, the depth information of the object to be projected from different visual angles can be obtained, and the object to be projected is modeled based on the depth information from the different visual angles. That is, alternatively, in some embodiments of this application, the method further includes:

based on the speckle pattern, obtaining the depth information of the object to be projected at other visual angles of the current moment except the current visual angle; and

modeling the object to be projected based on the obtained depth information to obtain a three-dimensional object model at the current moment.

Wherein, in the embodiment of this application, after obtaining the depth information of the object to be projected from multiple visual angles at the same time, the object to be projected can be reconstructed by means of point cloud reconstruction to obtain the three-dimensional object model of the object to be projected.

In the embodiment of this application, after obtaining the three-dimensional object model of the object to be projected, a volumetric video can further be generated based on the three-dimensional object model. That is, alternatively, in some embodiments of this application, the operation of “modeling the object to be projected based on the obtained depth information to obtain a three-dimensional object model at the current moment” includes:

modeling the object to be projected at other moments except the current moment to obtain a three-dimensional object model of the object to be projected at the other moments; and

performing video coding on the modeled three-dimensional object model according to a time sequence to obtain the volumetric video of the object to be projected.

The volumetric video (also called spatial video, three-dimensional volumetric video or 6-degree-of-freedom video, etc.) is a technology that captures information in three-dimensional space (such as depth information and color information) and generates a three-dimensional model sequence. Compared with a traditional video, the volumetric video adds a concept of space to a video, and uses the three-dimensional model to better restore a real three-dimensional world, instead of using a two-dimensional flat video and a mirror to simulate a space sense of the real three-dimensional world. Because the volumetric video is actually the three-dimensional model sequence, the user can adjust to any visual angle according to their own preferences for watching, and it has a higher degree of restoration and immersion than the two-dimensional flat video.

Alternatively, in this application, the three-dimensional model used to construct the volumetric video can be reconstructed as follows:

firstly, obtaining color images and depth images of a shooting object from different visual angles, and camera parameters corresponding to the color images; then, based on the obtained color images, the corresponding depth images, and the corresponding camera parameters, training a neural network model that implicitly expresses the three-dimensional object model; and performing an iso-surface extraction based on the trained neural network model, and implementing the three-dimensional object reconstruction of the shooting object to obtain a three-dimensional model of the shooting object.

It should be noted that, in the embodiment of this application, there is no specific limitation on which architecture neural network model is adopted, and those skilled in the art can select according to actual requirements. For example, a multilayer perceptron (MLP) without normalization layers can be selected as a basic model for model training.

The three-dimensional model reconstruction method provided in this application will be described in detail below.

Firstly, multiple color cameras and depth cameras can be simultaneously used to shoot a target object (that is, the target object is the shooting object) from multiple visual angles, so as to obtain the color images and corresponding depth images of the target object at multiple different visual angles. That is, at the same shooting moment (a difference between actual shooting moments is less than or equal to a time threshold, that is, the shooting moments are considered to be same), a color camera of each visual angle will capture a color image of the target object in the corresponding visual angle.

Correspondingly, a depth camera of each visual angle will capture a depth image of the target object in the corresponding visual angle. It should be noted that the target object can be any object, including but not limited to living objects such as humans, animals, and plants, or inanimate objects such as machinery, furniture, and dolls.

Therefore, the color images of the target object at different visual angles have the corresponding depth images. That is, when shooting, the color camera and the depth camera can adopt configuration of a camera group, and the color camera and the depth camera with the same visual angle cooperate to synchronously shoot the same target object. For example, a studio can be built, and a central area of the studio is a shooting area. Around the shooting area, a plurality of groups of color cameras and depth cameras are configured in pair every certain angle in a lateral and a longitudinal direction. When the target object is in the shooting area surrounded by these color cameras and depth cameras, the color images and the corresponding depth images of the target object at different visual angles can be obtained through these color cameras and depth cameras.

In addition, the camera parameters of the color camera corresponding to each color image are further obtained. The camera parameters include an internal parameter and an external parameter of the color cameras, which can be determined by calibration. The internal parameter is a parameter related to characteristics of the color cameras, including but not limited to a focal length and pixels of color cameras. The external parameter is a parameter of the color cameras in a world coordinate system, including but not limited to a position (a coordinate) and a rotation direction of the color cameras.

As mentioned above, after obtaining the plurality of color images and the corresponding depth images of the target object at the same shooting moment, a three-dimensional reconstruction can be performed on the target object based on the color images and the corresponding depth images. Different from a method of converting the depth information into point cloud for three-dimensional reconstruction in related technologies, this application trains a neural network model to implicitly express the three-dimensional model of the target object, so as to realize the three-dimensional reconstruction of the target object based on the neural network model.

Alternatively, this application selects one multilayer perceptron (MLP) without the normalization layers as the basic model, and trains the model according to the following method:

converting a pixel in each color image into rays based on the corresponding camera parameters;

sampling a plurality of sampling points on the rays, and determining first coordinate information of each sampling point and a signed distance field (SDF) value of each sampling point from the pixel;

inputting the first coordinate information of the sampling points into the basic model to obtain the predicted SDF value and the predicted RGB color value of each sampling point output by the basic model; and

adjusting parameters of the basic model based on a first difference between the predicted SDF value and the SDF value and a second difference between the predicted RGB color value and an RGB color value of the pixel until a preset termination condition is satisfied.

The basic model satisfying the preset termination condition is determined as the neural network model that implicitly expresses the three-dimensional model of the target object.

Firstly, based on the camera parameters corresponding to the color image, one pixel in the color image is converted into one ray. The ray can be a ray passing through the pixel and perpendicular to a color image plane. Then, the plurality of sampling points are sampled on the ray. A sampling process of sampling the points can be performed in two steps. Some sampling points can be uniformly sampled at first, and then a plurality of sampling points are further sampled at key points based on a depth value of the pixel, so as to ensure that as many sampling points can be sampled near a model surface as possible. Then, the first coordinate information of each sampling point in the world coordinate system and the signed distance field (SDF) value of each sampling point obtained by sampling are calculated based on the camera parameter and the depth value of the pixel.

The SDF value can be a difference value between the depth value of the pixel and a distance between the sampling point and a camera imaging surface. The difference value is a signed value. When the difference value is positive, it indicates that the sampling point is outside the three-dimensional model. When the difference value is negative, it indicates that the sampling point is inside the three-dimensional model. When the difference value is zero, it indicates that the sampling point is on a surface of the three-dimensional model. Then, after sampling the sampling point and calculating the SDF value corresponding to each sampling point, further, the first coordinate information of the sampling point in the world coordinate system is input into the basic model (the basic model is configured to map input coordinate information to an SDF value and an RGB color value and then output the SDF value and RGB color value), the SDF value output by the basic model is recorded as the predicted SDF value, and the RGB color value output by the basic model is recorded as the predicted RGB color value. Then, based on the first difference between the predicted SDF value and the SDF value corresponding to the sampling point and the second difference between the predicted RGB color value and the RGB color value of the pixel corresponding to the sampling point, the parameters of the basic model are adjusted.

In addition, for other pixels in the color image, sampling points are sampled in a same way as described above, and then coordinate information of the sampling points in the world coordinate system is input into the basic model to obtain corresponding predicted SDF values and predicted RGB color values, which are used to adjust the parameters of the basic model until the preset termination condition is satisfied. For example, the preset termination condition can be configured such that iteration times of the basic model reaches preset times, or the preset termination condition can be configured such that the basic model converges. When an iteration of the basic model satisfies the preset termination condition, the neural network model that can accurately and implicitly express the three-dimensional model of the shooting object is obtained. Finally, an iso-surface extraction algorithm can be used to extract a three-dimensional model surface of the neural network model, so as to obtain the three-dimensional model of the shooting object.

Alternatively, in some embodiments, an imaging plane of the color image is determined based on the camera parameters. A ray passing through the pixel in the color image and perpendicular to the imaging plane is determined as the ray corresponding to the pixel.

Wherein, coordinate information of the color image in the world coordinate system can be determined based on the camera parameters of the color camera corresponding to the color image, that is, the imaging plane can be determined. Then, the ray passing through the pixel in the color image and perpendicular to the imaging plane can be determined as the ray corresponding to the pixel.

Alternatively, in some embodiments, second coordinate information and a rotation angle of the color camera in the world coordinate system can be determined based on the camera parameters. The imaging plane of the color image is determined based on the second coordinate information and the rotation angle.

Optionally, in some embodiments, a first number of first sampling points are sampled at equal intervals on the ray. A plurality of key sampling points are determined based on the depth values of pixels, and a second number of second sampling points are sampled based on the key sampling points. The first number of first sampling points and the second number of second sampling points are determined as the plurality of sampling points sampled on the ray.

Wherein, firstly, n (i.e., the first number) first sampling points are uniformly sampled on the ray, where n is a positive integer greater than 2. Then, based on the depth value of the above described pixel, a preset number of key sampling points closest to the above described pixel are determined from the n first sampling points, or key sampling points, distances from which to the above described pixel are less than a distance threshold, are determined from the N first sampling points. Then, m second sampling points are re-sampled based on the determined key sampling points, where m is a positive integer greater than 1. Finally, the n+m sampling points obtained by sampling are determined as the plurality of sampling points obtained by sampling on the ray. Through sampling the M more sampling points at the key sampling points, a training effect of the model on the surface of the three-dimensional model can be more accurate, thus improving a reconstruction accuracy of the three-dimensional model.

Alternatively, in some embodiments, the depth value corresponding to the pixel is determined based on the depth image corresponding to the color image; the SDF value of each sampling point from the pixel is calculated based on the depth value; the coordinate information of each sampling point is calculated based on camera parameters and depth values.

Wherein, after sampling the plurality of sampling points on the ray corresponding to each pixel, for each sampling point, a distance between a shooting position of the color camera and a corresponding point on the target object is determined based on the camera parameters and the depth value of the pixel, and then the SDF value of each sampling point and the coordinate information of each sampling point are calculated one by one based on the distance.

It should be noted that after the training of the basic model is completed, for coordinate information of any given point, the corresponding SDF value can be predicted by the trained basic model. The predicted SDF value indicates a positional relationship (inside, outside, or on the surface) between the point and the three-dimensional model of the target object, thus realizing implicit expression of the three-dimensional model of the target object, and obtaining the neural network model that implicitly expresses the three-dimensional model of the target object.

Finally, the iso-surface extraction is performed on the above neural network model.

For example, the surface of the three-dimensional model can be drawn by using the iso-surface extraction algorithm (marching cubes, MC) to obtain the three-dimensional model surface, and then the three-dimensional model of the target object can be obtained based on the surface of the three-dimensional model.

The three-dimensional reconstruction scheme provided by this application implicitly models the three-dimensional model of the target object through a neural network, and adds depth information to improve a speed and an accuracy of model training. By adopting the three-dimensional reconstruction scheme provided by this application, the three-dimensional models of the shooting object at different moments can be obtained by continuously performing the three-dimensional reconstruction on the shooting object in a time sequence. The three-dimensional model sequence formed by these three-dimensional models at different moments according to the time sequence is the volumetric video captured by shooting the shooting object. Therefore, a “volumetric video shooting” can be carried out for any shooting object, and a volumetric video presented with specific content can be obtained. For example, the volumetric video shooting can be performed on a shooting object that is dancing, so as to obtain a volumetric video in which the dancing of the shooting object can be watched from any angle; the volumetric video shooting can be performed on a shooting object that is teaching, so as to obtain a volumetric video in which the teaching of the shooting object can be watched from any angle, and the like.

This application divides a projection area of a speckle projector into a plurality of polygons; obtains a plurality of candidate projection points and a plurality of candidate projection edges based on vertices and edges of the polygons; by generating a random number, selects the target projection point from the plurality of candidate projection points and selects the target projection edge from the plurality of candidate projection edges based on the random number; and then generates the speckle pattern based on the selected target projection point and the selected target projection edge. Wherein, by constructing the speckle pattern through the points and edges, diversity of the speckle pattern texture is enriched. Compared to speckles constructed by random points in the related art, it is easier to obtain texture of a surface of a projected object through speckles constructed by the points and edges in the present solution. Selecting the projection points and edges based on the random numbers improves randomness of the speckle pattern, and such a random way can also make speckles more uniform to a certain extent. By dividing the projection area of the speckle projector into the plurality of polygons, and taking the vertices and the edges of the polygons as the candidate projection points and the candidate projection edges, the speckle density can be controlled by controlling sizes of the polygons.

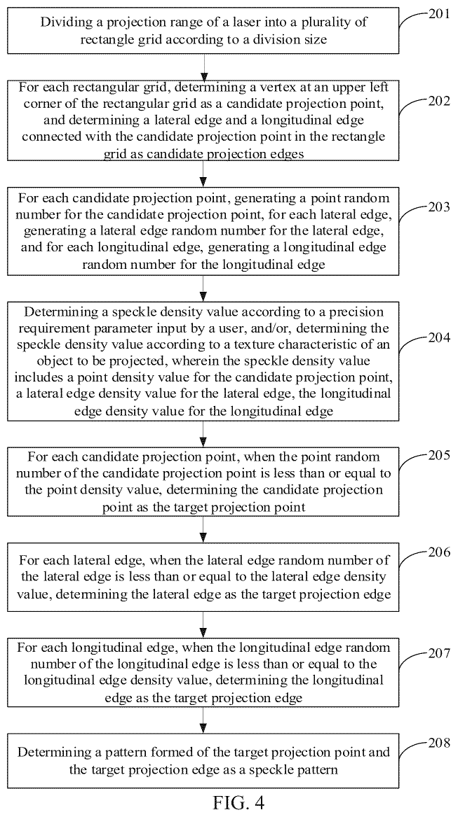

Please refer to FIG. 4, FIG. 4 is a flow diagram of a rectangle-based speckle generation method provided by an embodiment of this application. The flow of the rectangle-based speckle generation method specifically includes:

201: dividing a projection range of a laser into a plurality of rectangle grids according to a division size;

202: for each rectangular grid, determining a vertex at an upper left corner of the rectangular grid as a candidate projection point, and determining a lateral edge and a longitudinal edge connected with the candidate projection point in the rectangle grid as candidate projection edges;

203: for each candidate projection point, generating a point random number for the candidate projection point, for each lateral edge, generating a lateral edge random number for the lateral edge, and for each longitudinal edge, generating a longitudinal edge random number for the longitudinal edge;

204: determining a speckle density value according to a precision requirement parameter input by a user, and/or, determining the speckle density value according to a texture characteristic of an object to be projected, wherein the speckle density value includes a point density value for the candidate projection point, a lateral edge density value for the lateral edge, the longitudinal edge density value for the longitudinal edge. Wherein, the point random number and the point density value have a same value range, the lateral edge random number and the lateral edge density value have a same value range, and the longitudinal edge random number and the longitudinal edge density value have a same value range.

205: for each candidate projection point, when the point random number of the candidate projection point is less than or equal to the point density value, determining the candidate projection point as the target projection point;

206: for each lateral edge, when the lateral edge random number of the lateral edge is less than or equal to the lateral edge density value, determining the lateral edge as the target projection edge;

207: for each longitudinal edge, when the longitudinal edge random number of the longitudinal edge is less than or equal to the longitudinal edge density value, determining the longitudinal edge as the target projection edge;

208: determining a pattern formed of the target projection point and the target projection edge as a speckle pattern.

In the embodiment of this application, when the point density value ranges from 0 to 1 and the point density value is 0, the emission range of the laser does not include the target projection, and when the point density value is 1, each vertex of the rectangle is taken as the target projection point.

Wherein, in the embodiment of this application, the lateral density value and the longitudinal density value are 0.5 by default.

Wherein, in the embodiment of this application, the projection point, the lateral projection edge, and the longitudinal projection edge can be controlled respectively. For example, by adjusting the point density value, the lateral edge density value, and the longitudinal edge density value respectively, the speckle patterns with different types or different density requirements can be obtained.

For example, in an embodiment of this application, the lateral edge density value corresponding to the lateral projection edge is set to 0, and the longitudinal edge density value corresponding to the longitudinal projection edge is set to zero, so that the speckle pattern only consists of projection points. Please refer to FIG. 5, FIG. 5 is a first schematic picture of a speckle pattern provided by the embodiment of this application, wherein the speckle pattern only includes projection points and does not include projection edges.

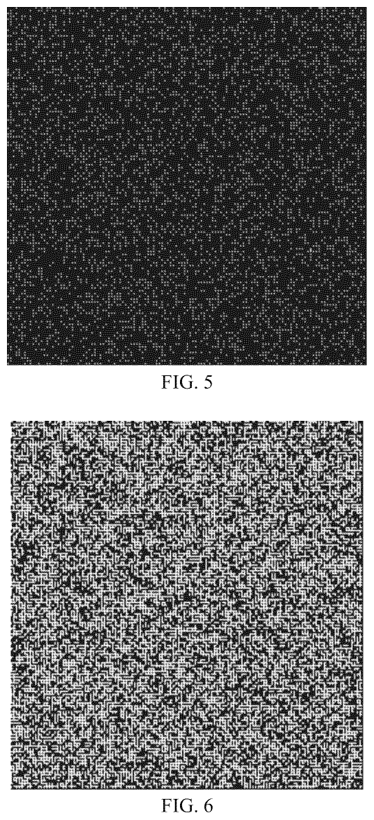

For example, in an embodiment of this application, the point density value of the projection points can also be set to zero, so that the speckle pattern only consists of projection edges. Please refer to FIG. 6, FIG. 6 is a second schematic picture of the speckle pattern provided by an embodiment of this application, wherein the speckle pattern only consists of projection edges and does not include projection points.

For example, in an embodiment of this application, the speckle pattern can also be set to be dominated by lateral edges (increase a difference between the lateral edge density value and the longitudinal edge density value, and ensure that the lateral edge density value is larger than the longitudinal edge density value). Please refer to FIG. 7, FIG. 7 is a third schematic picture of the speckle pattern provided by an embodiment of this application, wherein the speckle pattern is dominated by the lateral edges.

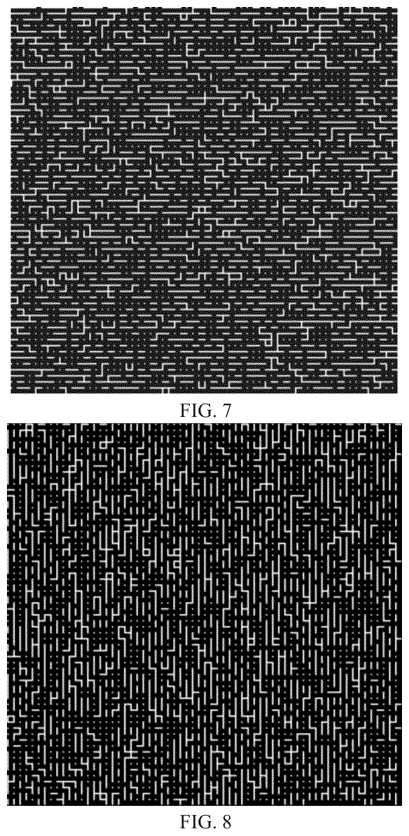

As another example, in an embodiment of this application, the speckle pattern can also be set to be dominated by longitudinal edges (increase a difference between the longitudinal edge density value and the lateral edge density value, and ensure that the longitudinal edge density value is larger than the lateral edge density value). Please refer to FIG. 8, FIG. 8 is a fourth schematic picture of the speckle pattern provided by an embodiment of this application, wherein the speckle pattern is dominated by the longitudinal edges.

Wherein, in an embodiment of this application, by dividing an emission range of a laser into a plurality of rectangular grids, the projection points and the projection edges are determined from the vertices and the edges of the rectangular grids, and the generation of the speckle pattern is realized after the laser is projected onto the projection points and the projection edges. Wherein, since the projection points and the projection edges are on the rectangular grids, the speckle density can be adjusted after adjusting sizes of the rectangular grids. Therefore, according to the embodiment of the invention, the emission range of the laser is divided into the plurality of rectangular grids, so that sparse density of a board pattern can be adjusted according to an adjustment of the sizes of the grids, and the speckle pattern with controllable sparse density can facilitate surface texture obtaining of corresponding different objects.

Wherein, please refer to FIG. 9, FIG. 9 is a schematic picture of random speckles based on projection points in the related art, wherein the projection points in the random speckle are random. Thus, it is difficult to control density and uniformity of the projection points, which is not conducive to obtaining surface texture information of a fine object.

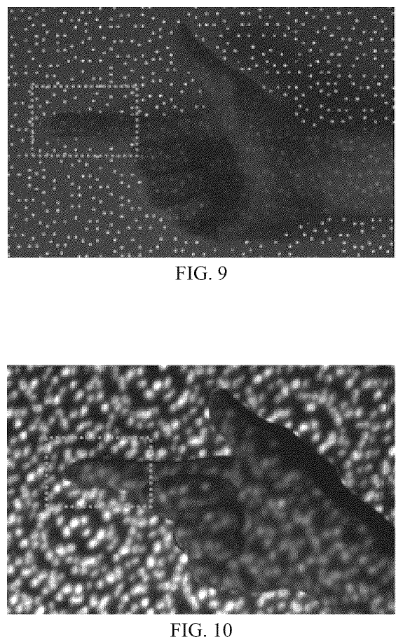

Moreover, the random speckle based on the projection point still can't get clear or accurate texture information of the object surface after the projection point increases. Please refer to FIG. 10, FIG. 10 is a schematic picture of another random speckle pattern based on the projection points in the related ar. Hand texture information obtained in this figure has been improved, but it is still not conducive to refined calculation of hand depth information.

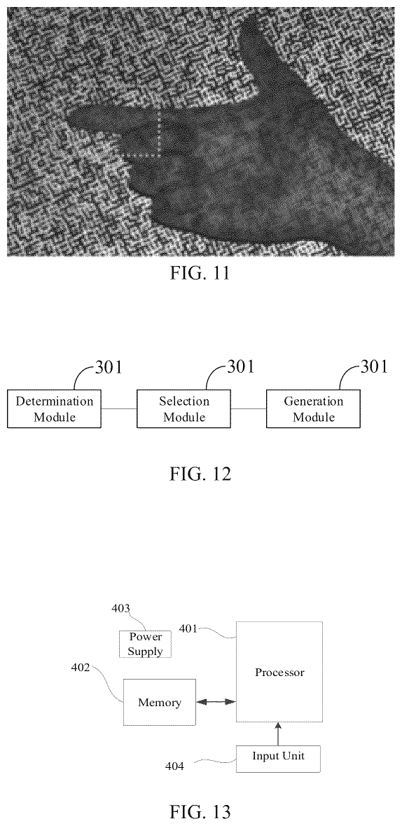

However, based on the generation method of the speckle pattern in the embodiment of this application, the fine hand texture can be collected. For example, please refer to FIG. 11, FIG. 11 is a schematic picture of speckle pattern application provided by an embodiment of this application. Wherein, since the projection points and the projection edges are controlled based on the sizes of the rectangular grids in the embodiment of this application. In this embodiment of this application, the density of the projection points and the projection edges and the uniformity of the projection points and the projection edges in a projection range picture can be adjusted according to a size change of the rectangular grids. Therefore, for the fine object, the density of the projection points and the projection edges can be increased, and the speckle density can be further increased, so as to obtain more accurate texture information of a surface of the object. That is, through a refined speckle pattern, a combination of point speckles and short edge speckles as well as the improvement of density and sparsity, it is beneficial to realize a collection of fine texture of a hand and thus obtain more accurate hand depth information.

Wherein, in the embodiment of this application, after the speckle pattern of the laser is obtained, the speckle pattern can be projected on an object to be projected. The texture information of the surface of the object to be projected can be collected and calculated through the speckle pattern, and a parallax of a binocular camera is matched, so as to obtain more accurate depth information of the object to be projected.

Wherein, in the embodiment of this application, after the depth information of the object to be projected is obtained, a three-dimensional reconstruction can be performed on the object to be projected based on depth information from different visual angles. For example, based on the depth information of different visual angles of the object to be projected, the three-dimensional model of the object to be projected can be obtained by means of point cloud computing.

Wherein, in the embodiment of this application, after obtaining the three-dimensional model of the object to be projected, a volumetric video can be generated based on the three-dimensional model. For example, the three-dimensional models are connected based on a sequence to obtain the corresponding volumetric video.

In order to better implement the speckle generation method of this application, this application also provides a speckle generation apparatus based on the speckle generation method. The meaning of a word is the same as that in the above speckle generation method, and the specific implementation details can refer to the description in the method embodiment.

Please refer to FIG. 12, FIG. 12 is a schematic structural diagram of a speckle generation apparatus provided by an embodiment of this application. the speckle generation device may include:

a determination module 301 configured to drive a projection area of a speckle projector into a plurality of polygons 301, and determine a plurality of candidate projection points and a plurality of candidate projection edges based on vertices and edges of the polygons;

a selection module 302 configured to generate a random number 302, and select a target projection point from the plurality of candidate projection points and select a target projection edge from the plurality of candidate projection edges based on the random number; and

a generation module 303 configured to generate a speckle pattern based on the target projection point and the target projection edge.

Wherein, in some embodiments of this application, the selection module 302 includes:

a density determination unit configured to determine a speckle density value;

a selection unit configured to generate the random number, and select the target projection point from the plurality of candidate projection points and select the target projection edge from the plurality of candidate projection edges based on a comparison result between the random number and the speckle density value.

Wherein, in some embodiments of this application, the selection module includes:

a density determination subunit configured to determine the speckle density value according to a precision requirement parameter of an input, and/or, determine the speckle density value according to a texture characteristic of an object to be projected.

Wherein, in some embodiments of this application, the selection module includes:

a generation subunit configured to generate a point random number for each of the candidate projection points, and generate an edge random number for each of the candidate projection edges;

a first selection subunit configured to select the target projection point from the plurality of candidate projection points based on a comparison result between the point random number for each of the candidate projection points and the speckle density value; and

a second selection subunit configured to select the target projection edge from the plurality of candidate projection edges based on a comparison result between the edge random number for each of the candidate projection edges and the speckle edge density value.

Wherein, in some embodiments of this application, the speckle density value includes a point density value, and the first selection subunit is specifically configured to:

for each of the candidate projection points, determine a point selection state of the candidate projection point based on the comparison result between the point random number of the candidate projection point and the point density value; and

determine the target projection point from the plurality of candidate projection points based on the point selection state of each of the candidate projection points.

Wherein, in some embodiments of this application, the speckle density value includes an edge density value, and the second selection subunit is specifically configured to:

for each of the candidate projection edges, determine an edge selection state of the candidate projection edge based on the comparison result between the edge random number of the candidate projection edge and the edge density value; and

determine the target projection edge from the plurality of candidate projection edges based on the edge selection state of each of the candidate projection edges.

Wherein, in some embodiments of this application, the plurality of polygons include rectangles, and the determination module 301 includes:

a point determination unit configured to, for each of the rectangles, take any one vertex of the rectangle as a candidate projection point, and positions of the candidate projection points corresponding to the rectangles are consistent, wherein the positions include a position of the candidate projection point relative to the rectangle; and

an edge determination unit configured to take two edges of the rectangle connected with the candidate projection point as the candidate projection edges respectively.

Wherein, in some embodiments of this application, the two sides include first edges and second edges, the speckle density value includes a first edge density value corresponding to the first edges and a second edge density value corresponding to the second edges, and the second selection subunit is further specifically configured to:

for each of the first edges, determine an edge selection state of the first edge based on a comparison result between an edge random number corresponding to the first edge and the first edge density value; and

for each of the second edges, determine an edge selection state of the second edge based on a comparison result between an edge random number corresponding to the second edge and the second edge density value.

Wherein, in some embodiments of this application, the determination module 301 includes:

a size determination unit configured to, in response to a speckle generation instruction for the projection area of the speckle projector, determine a division size; and

a division unit configured to divide the projection area of the speckle projector into a plurality of polygons.

Wherein, in some embodiments of this application, the apparatus further includes a depth calculation module, and the depth calculation module includes:

a projection unit configured to project the speckle pattern to an object to be projected at a current visual angle of a current moment;

a shooting unit configured to shoot the object to be projected that has been projected by a binocular camera to obtain a first shot image and a second shot image; and

a calculation unit configured to, based on a parallax error of the speckle pattern in the first shot image and the second shot image, determine depth information of the object to be projected at the current visual angle of the current moment.

Wherein, in some embodiments of this application, the apparatus further includes a modeling module, and the modeling module includes:

an obtaining unit configured to, based on the speckle pattern, obtain depth information of the object to be projected at other visual angles of the current moment except the current visual angle; and

a modeling unit configured to model the object to be projected based on the obtained depth information to obtain a three-dimensional object model at the current moment.

Wherein, in some embodiments of this application, the apparatus further includes a volumetric video generation module, and the volumetric video includes:

a multi-moment modeling unit configured to model the object to be projected at other moments except the current moment to obtain a three-dimensional object model of the object to be projected at the other moment; and

a volumetric video generation unit configured to perform video coding on the modeled three-dimensional object model according to a time sequence to obtain a volumetric video of the object to be projected.

In this embodiment of this application, the determination module 301 divides a projection area of a speckle projector into a plurality of polygons, and determines a plurality of candidate projected points and a plurality of candidate projected edges based on vertices and edges of the polygons. Then, the selection module 302 generates a random number, and selects a target projection point from the plurality of candidate projection points and selects a target projection edge from the plurality of candidate projection edges based on the random number. Then, the generation module 303 generates a speckle pattern based on the target projection point and the target projection edge.

The embodiment of this application divides a projection area of a speckle projector into a plurality of polygons, and obtains a plurality of candidate projection points and a plurality of candidate projection edges based on vertices and edges of the polygons; by generating a random number, selects a target projection point from the plurality of candidate projection points and selects a target projection edge from the plurality of candidate projection edges based on the random number; and then generates a speckle pattern based on the selected target projection point and the selected target projection edge. By constructing the speckle pattern through the points and edges, diversity of the speckle pattern texture is enriched. Compared to speckles constructed by random points in the related art, it is easier to obtain texture of a surface of a projected object through the speckles constructed by the points and edges in the present solution. Wherein, selecting the projection points and edges based on the random numbers improves randomness of the speckle pattern, and such a random way can also make speckles more uniform to a certain extent. By dividing the projection area of the speckle projector into the plurality of polygons, and taking the vertices and the edges of the polygons as the candidate projection points and the candidate projection edges, the speckle density can be controlled by controlling sizes of the polygons.

In addition, this application also provides an electronic device, as shown in FIG. 13, which shows a schematic structural diagram of the electronic device related to this application, specifically:

The electronic device may include a processor 401 of one or more processing cores, a memory 402 of one or more computer-readable storage media, a power supply 403, an input unit 404 and other components. It can be understood by those skilled in the art that the electronic device structure shown in FIG. 13 does not limit the electronic device, and may include more or less components than those shown, or combine some components, or different component arrangements. Wherein:

The processor 401 is a control center of the electronic device, connecting various parts of the whole electronic device with various interfaces and lines, executing various functions of the electronic device and processing data by running or executing software programs and/or modules stored in the memory 402 and calling the data stored in the memory 402. Alternatively, the processor 401 may include one or more processing cores. Preferably, the processor 401 can integrate an application processor and a modem processor, wherein this application processor mainly processes operating systems, object interfaces, application programs, etc., and the modem processor mainly processes wireless communication. It can be understood that the above modem processor may not be integrated into the processor 401.

The memory 402 can be used to store software programs and modules, and the processor 401 executes various functional applications and data processing by running the software programs and modules stored in the memory 402. The memory 402 can mainly include a storage program area and a storage data area. The storage program area can store operating systems, application programs required by at least one function (such as sound playing function, image playing function, etc.), etc. The storage data area can store data created according to use of the electronic device, etc. In addition, the memory 402 may include a high-speed random-access memory and a nonvolatile memory, such as at least one disk memory device, a flash memory device, or other volatile solid-state memory devices. Accordingly, the memory 402 may also include a memory controller to provide the processor 401 with access to the memory 402.

The electronic device further includes a power supply 403 for supplying power to various components. Preferably, the power supply 403 can be logically connected to the processor 401 through a power management system, so that functions of managing charging, discharging, and power consumption management can be realized through the power management system. The power supply 403 may further include one or more DC or AC power supplies, a recharging system, a power failure detection circuit, a power converter or inverter, a power status indicator, and any other components.

The electronic device may also include an input unit 404, which may be used to receive input digital or character information and generate keyboard, mouse, joystick, optical or trackball signal input related to object setting and function control.

Although not shown, the electronic device may also include a display unit and the like, which will not be described here. In this embodiment, the processor 401 in the electronic device will load executable files corresponding to processes of one or more application programs into the memory 402 according to the following instructions, and the processor 401 will run this application programs stored in the memory 402, thus realizing the steps in any speckle generation method provided in this application.

This application divides a projection area of a speckle projector into a plurality of polygons; obtains a plurality of candidate projection points and a plurality of candidate projection edges based on vertices and edges of the polygons; by generating a random number, selects the target projection point from the plurality of candidate projection points and selects the target projection edge from the plurality of candidate projection edges based on the random number; and then generates the speckle pattern based on the selected target projection point and the selected target projection edge. Wherein, by constructing the speckle pattern through the points and edges, diversity of the speckle pattern texture is enriched. Compared to speckles constructed by random points in the related art, it is easier to obtain texture of a surface of a projected object through speckles constructed by the points and edges in the present solution. Selecting the projection points and edges based on the random numbers improves randomness of the speckle pattern, and such a random way can also make speckles more uniform to a certain extent. By dividing the projection area of the speckle projector into the plurality of polygons, and taking the vertices and the edges of the polygons as the candidate projection points and the candidate projection edges, the speckle density can be controlled by controlling sizes of the polygons.

Those of ordinary skill in the art can understand that all or part of the steps in the various methods of the above embodiments can be completed by instructions, or related hardware can be controlled by instructions, which can be stored in a computer-readable storage medium and loaded and executed by a processor.

To this end, this application also provides a computer readable storage medium, on which a computer program is stored. The computer program can be uploaded by a processor, so as to implement the steps of the speckle generation method as described above.

Wherein, the computer readable storage medium may include: a read only memory (ROM), a random access memory (RAM), a magnetic disk, or an optical disk, etc.

Because the instructions stored in the computer-readable storage medium can execute the steps of any speckle generation method provided in this application, the beneficial effects that can be achieved by any speckle generation method provided in this application can be realized. For details, please refer to the previous embodiments, which will not be repeated here.

The speckle generation method, device, electronic equipment and computer readable storage medium provided by the above application are introduced in detail. In this paper, the principle and implementation of the present invention are explained by specific examples, and the explanations of the above embodiments are only used to help understand the method and its core ideas of the present invention. Meanwhile, for those skilled in the art, according to the idea of the present invention, there will be changes in the specific implementation and application scope. To sum up, the contents of this specification should not be construed as a limitation of the present invention.

What is claimed is:

1. A speckle generation method, wherein the method comprises:
dividing a projection area of a speckle projector into a plurality of polygons, and determining a plurality of candidate projection points and a plurality of candidate projection edges based on vertices and edges of the polygons;
generating a random number, and selecting a target projection point from the plurality of candidate projection points and selecting a target projection edge from the plurality of candidate projection edges based on the random number; and
generating a speckle pattern based on the target projection point and the target projection edge.

2. The method as claimed in claim 1, wherein the generating the random number, and selecting the target projection point from the plurality of candidate projection points and selecting the target projection edge from the plurality of candidate projection edges based on the random number comprises:
determining a speckle density value; and
generating the random number, and selecting the target projection point from the plurality of candidate projection points and selecting the target projection edge from the plurality of candidate projection edges based on a comparison result between the random number and the speckle density value.

3. The method as claimed in claim 2, wherein the determining the speckle density value comprises:
determining the speckle density value according to a precision requirement parameter of an input,
and/or, determining the speckle density value according to a texture characteristic of an object to be projected.

4. The method as claimed in claim 2, wherein the generating the random number, and selecting the target projection point from the plurality of candidate projection points and selecting the target projection edge from the plurality of candidate projection edges based on the comparison result between the random number and the speckle density value comprises:
generating a point random number for each of the candidate projection points, and generating an edge random number for each of the candidate projection edges;
selecting the target projection point from the plurality of candidate projection points based on a comparison result between the point random number for each of the candidate projection points and the speckle density value; and
selecting the target projection edge from the plurality of candidate projection edges based on a comparison result between the edge random number for each of the candidate projection edges and the speckle density value.

5. The method as claimed in claim 4, wherein the speckle density value comprises a point density value, and the selecting the target projection point from the plurality of candidate projection points based on the comparison result between the point random number for each of the candidate projection points and the speckle density value comprises:
for each of the candidate projection points, determining a point selection state of the candidate projection point based on the comparison result between the point random number of the candidate projection point and the point density value; and
determining the target projection point from the plurality of candidate projection points based on the point selection state of each of the candidate projection points.

6. The method as claimed in claim 4, wherein the speckle density value comprises an edge density value, the selecting the target projection edge from the plurality of candidate projection edges based on the comparison result between the edge random number for each of the candidate projection edges and the speckle density value:
for each of the candidate projection edges, determining an edge selection state of the candidate projection edge based on the comparison result between the edge random number of the candidate projection edge and the edge density value; and
determining the target projection edge from the plurality of candidate projection edges based on the edge selection state of each of the candidate projection edges.

7. The method as claimed in claim 6, wherein the plurality of polygons comprise rectangles, the determining the plurality of candidate projection points and the plurality of candidate projection edges based on the vertices and the edges of the polygons;
for each of the rectangles, taking any one vertex of the rectangle as a candidate projection point, and positions of the candidate projection points corresponding to the rectangles are consistent, wherein the positions comprise a position of the candidate projection point relative to the rectangle; and
taking two edges of the rectangle connected with the candidate projection point as the candidate projection edges respectively.

8. The method as claimed in claim 7, wherein the two edges comprises first edges and second edges, the speckle density value comprises a first edge density value corresponding to the first edges and a second edge density value corresponding to the second edges, and the determining, for each of the candidate projection edges, the edge selection state of the candidate projection edge based on the comparison result between the edge random number of the candidate projection edge and the edge density value comprises:
for each of the first edges, determining an edge selection state of the first edge based on a comparison result between an edge random number corresponding to the first edge and the first edge density value; and
for each of the second edges, determining an edge selection state of the second edge based on a comparison result between an edge random number corresponding to the second edge and the second edge density value.

9. The method as claimed in claim 1, wherein the dividing the projection area of the speckle projector into the plurality of polygons comprises:
in response to a speckle generation instruction for the projection area of the speckle projector, determining a division size; and
dividing the projection area of the speckle projector into the plurality of polygons.

10. The method as claimed in claim 1, wherein after the generating the speckle pattern based on the target projection point and the target projection, the method further comprises:
projecting the speckle pattern to an object to be projected at a current visual angle of a current moment;
shooting the object to be projected that has been projected by a binocular camera to obtain a first shot image and a second shot image; and
based on a parallax error of the speckle pattern in the first shot image and the second shot image, determining depth information of the object to be projected at the current visual angle of the current moment.

11. The method as claimed in claim 10, wherein the method further comprises:
based on the speckle pattern, obtaining depth information of the object to be projected at other visual angles of the current moment except the current visual angle; and
modeling the object to be projected based on the obtained depth information to obtain a three-dimensional object model at the current moment.

12. The method as claimed in claim 11, wherein after the modeling the object to be projected based on the obtained depth information to obtain the three-dimensional object model at the current moment, the method further comprises:
modeling the object to be projected at other moments except the current moment to obtain a three-dimensional object model of the object to be projected at the other moments; and
performing video coding on the modeled three-dimensional object model according to a time sequence to obtain a volumetric video of the object to be projected.

13. An electronic device, wherein the electronic device comprises a memory, a processor, and a computer program stored in the memory and executable on the processor, and the processor executes the computer program to implement a speckle generation method, wherein the speckle generation method comprises:
dividing a projection area of a speckle projector into a plurality of polygons, and determining a plurality of candidate projection points and a plurality of candidate projection edges based on vertices and edges of the polygons;
generating a random number, and selecting a target projection point from the plurality of candidate projection points and selecting a target projection edge from the plurality of candidate projection edges based on the random number; and
generating a speckle pattern based on the target projection point and the target projection edge.

14. The electronic device as claimed in claim 13, wherein the generating the random number, and selecting the target projection point from the plurality of candidate projection points and selecting the target projection edge from the plurality of candidate projection edges based on the random number comprises:
determining a speckle density value; and
generating the random number, and selecting the target projection point from the plurality of candidate projection points and selecting the target projection edge from the plurality of candidate projection edges based on a comparison result between the random number and the speckle density value.

15. The electronic device as claimed in claim 14, wherein the determining the speckle density value comprises:
determining the speckle density value according to a precision requirement parameter of an input,
and/or, determining the speckle density value according to a texture characteristic of an object to be projected.

16. The electronic device as claimed in claim 14, wherein the generating the random number, and selecting the target projection point from the plurality of candidate projection points and selecting the target projection edge from the plurality of candidate projection edges based on the comparison result between the random number and the speckle density value comprises:
generating a point random number for each of the candidate projection points, and generating an edge random number for each of the candidate projection edges;
selecting the target projection point from the plurality of candidate projection points based on a comparison result between the point random number for each of the candidate projection points and the speckle density value; and
selecting the target projection edge from the plurality of candidate projection edges based on a comparison result between the edge random number for each of the candidate projection edges and the speckle density value.

17. The electronic device as claimed in claim 16, wherein the speckle density value comprises a point density value, and the selecting the target projection point from the plurality of candidate projection points based on the comparison result between the point random number for each of the candidate projection points and the speckle density value comprises:
for each of the candidate projection points, determining a point selection state of the candidate projection point based on the comparison result between the point random number of the candidate projection point and the point density value; and
determining the target projection point from the plurality of candidate projection points based on the point selection state of each of the candidate projection points.

18. The electronic device as claimed in claim 16, wherein the speckle density value comprises an edge density value, the selecting the target projection edge from the plurality of candidate projection edges based on the comparison result between the edge random number for each of the candidate projection edges and the speckle density value:
for each of the candidate projection edges, determining an edge selection state of the candidate projection edge based on the comparison result between the edge random number of the candidate projection edge and the edge density value; and
determining the target projection edge from the plurality of candidate projection edges based on the edge selection state of each of the candidate projection edges.

19. The electronic device as claimed in claim 18, wherein the plurality of polygons comprise rectangles, the determining the plurality of candidate projection points and the plurality of candidate projection edges based on the vertices and the edges of the polygons;
for each of the rectangles, taking any one vertex of the rectangle as a candidate projection point, and positions of the candidate projection points corresponding to the rectangles are consistent, wherein the positions comprise a position of the candidate projection point relative to the rectangle; and
taking two edges of the rectangle connected with the candidate projection point as the candidate projection edges respectively.

20. A computer readable storage medium on which a computer program is stored, and when executed by a processor, the computer program implements a speckle generation method, wherein the speckle generation method comprises:
dividing a projection area of a speckle projector into a plurality of polygons, and determining a plurality of candidate projection points and a plurality of candidate projection edges based on vertices and edges of the polygons;
generating a random number, and selecting a target projection point from the plurality of candidate projection points and selecting a target projection edge from the plurality of candidate projection edges based on the random number; and
generating a speckle pattern based on the target projection point and the target projection edge.
